(19) United States
(12) Patent Application Publication
(10) Pub. No.: US 2006/0021719 A1
(43) Pub. Date: Feb. 2, 2006

(54) Fabric slat of Venetian Blind and method of manufacturing

(76) Inventor: Chen-Ho Chu, Taipei (TW)

Correspondence Address: DAVID E. DOUGHERTY;Dennison, Schultz, Dougherty & Macdonald, Suite 105, 1727 King Street, Alexandria, VA, 22314-2700, US

(21) Appl. No.: 10/901,980

(22) Filed: Jul. 30, 2004

(51) Int. Cl. E06B 3/12

(52) U.S. Cl. 160/236

(57) ABSTRACT

A fabric slat of Venetian Blind, wherein a thin film such as aluminum film with suitable width and fabric material such as artificial fiber or blended fiber with heat-sealing property are used to form the slat by covering said fabric on the surrounding surface of said thin film and having both sides or one side of the excessive fabric heat-sealed and heat-cut. The adhesive is used to get an adherent layer between said thin film surface and said fabric surfaces, so that the said fabric become the outer cover surface of slat, in order to make the slat of Venetian Blind with fabric appearance and feeling to increase the decoration effect of Venetian Blind.

### BACKGROUND OF THE INVENTION

The present invention relates to a slat of Venetian Blind and method of manufacturing, and more particularly to a fabric slat showing fabric appearance and feeling to increase the decoration effect of Venetian Blind.

Venetian Blind is a common commodity for indoor designing. Its plural slats can be retracted or stretched easily and the angle can be adjusted to get light shielding function at various angles. For current Venetian Blind, the slat is categorized as aluminum slat or PVC (plastic ) slat, the width of slat is about 25-50 mm, the thickness is about 0.13 mm or more, and the arc shape is formed on wide surface, so as to increase the longitudinal support ing strength (rigidity) of slat, and the ladder string is used to maintain the slats of Venetian blind at horizontal status without bending or sagging. Though, common aluminum slat or PVC slat can have various colors, it can not show the appearance and feeling of fabric. And though fabric-made strip can be used to substitute common aluminum, PVC, or other slat, it has problem for insufficient rigidity on longitudinal direction. Even fabric-made strip can be coated with glue to increase the rigidity on longitudinal direction, its appearance is no longer like fabric but more like a piece of plastic. There is another method shown in U.S. Pat. No. 5,927,198. The U.S. Pat. No. 5,927,198 disclose a processing machine designed for fabric-made slat of Venetian Blind, wherein two tubular spaces are formed on two sides of the fabric-made slat for receiving two ribs therein to achieve a designated rigidity of the fabric-made slat. But the processing procedure is complicated and the cost is high. And the ribs on two sides of the fabric-made slat will increase the thickness of fabric-made slat, it will increase the area of retracted complex slats and the appearance is influenced.

### SUMMARY OF THE INVENTION

The primary object of the present invention is to provide a fabric slat of Venetian Blind, wherein a thin film such as aluminum film with suitable width and fabric material such as artificial fiber or blended fiber with heat-sealing property are used to form the slat by covering said fabric on the surrounding surface of said thin film and having both sides or one side of the excessive fabric heat-sealed and heat-cut. The adhesive is used to get an adherent layer between said thin film surface and said fabric surfaces, so that the said fabric become the outer cover surface of slat, in order to make the slat of Venetian Blind with fabric appearance and feeling to increase the decoration effect of Venetian Blind.

Another object of present invention is to provide a method of fabricating the fabric slat structure of Venetian Blind, which comprises the steps of: providing a thin aluminum film coil and two fabric coils, wherein the fabric of said two fabric coils is made up of fabric with heat-sealing property, and its width is wider than the thin aluminum film of said thin aluminum film coil; coating an adhesive layer on the top and bottom of said aluminum film with adhesive; laminating said two fabric on the top and bottom of said aluminum film with two fabric edge belts extending along both edges of said aluminum film; heat-sealing along the fabric edge belts so as to heat-seal both sides of two fabric; and heat-cutting/heat-trimming along the fabric edge belts so as to cut away the excessive materials of both sides of two fabric edge belts.

A further object of present invention is to provide a method of fabricating the fabric slat structure of Venetian Blind, which comprises the steps of: providing a thin aluminum film coil and a fabric coil, wherein the fabric of said fabric coil is made up of fabric with heat-sealing property, and its width is wider than the double width of the thin aluminum film of said thin aluminum film coil; coating an adhesive layer on the top and bottom of said aluminum film with adhesive; folding the fabric into half-and-half fabric; laminating said half-and-half fabric on the top and bottom of said aluminum film with two fabric edge belts extending along one edge of said aluminum film; heat-sealing along the fabric edge belts so as to heat-seal one side of half-and-half fabric; and heat-cutting/heat-trimming along the fabric edge belts so as to cut away the excessive materials of one side of two fabric edge belts.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective of a Venetian Blind showing the slats.

FIG. 2 is a perspective of a slat according to a first embodiment of the present invention.

FIG. 3 is a cross-sectional view of slat taken on the line 3-3 of FIG. 2.

FIG. 4 is a manufacturing process according to a first embodiment of the present invention disclosed in FIG. 3.

FIG. 5 is another cross-sectional view of slat taken on the line 3-3 of FIG. 2.

FIG. 6 is a manufacturing process according to a first embodiment of the present invention disclosed in FIG. 5.

### DETAILED DESCRIPTION OF THE PREFERRED EMBODIMENT

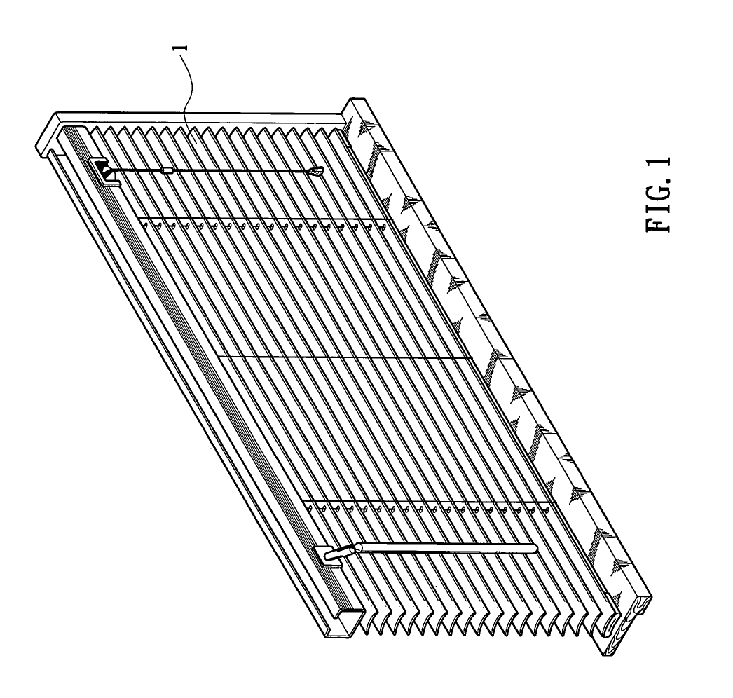

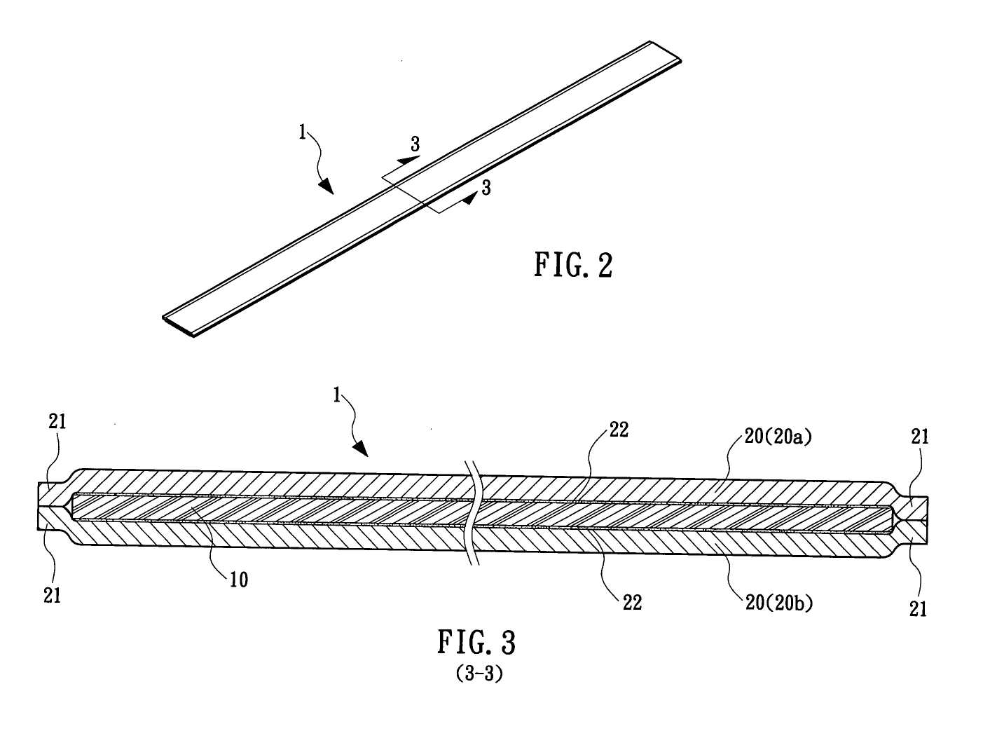

Referring to FIG. 1, 2, 3, the slat 1 of Venetian Blind of the present invention includes an inner thin film layer 10, and two outer layers 20 covered on both sides (top and bottom) of said inner thin film layer 10, wherein said inner thin film layer 10 is a thin film with suitable width and rigidity. Like the regular aluminum slat of Venetian Blind, its width is about 25-50 mm and thickness 0.13 mm or more. Two outer layers 20 are made up of fabric with heat-sealing property such as artificial fiber including polyester, nylon, or blended fiber etc. and they are slightly wider than the inner thin film layer 10. Two outer layers 20 (20a, 20b) are covered on the top and bottom of said inner thin film layer 10 with two edge belts 21 extending along both edges of said inner thin film layer 10. Because of the property of artificial fiber or blended fiber, the top and bottom outer layers 20a, 20b can be heat-sealed and heat-cut along the edge belts 21 to form a solid piece with the inner thin film layer 10 in between. And an adhesive layer 22 can be used to let two outer layers 20 and the inner thin film layer 10 tightly stick together to form the slat of Venetian Blind.

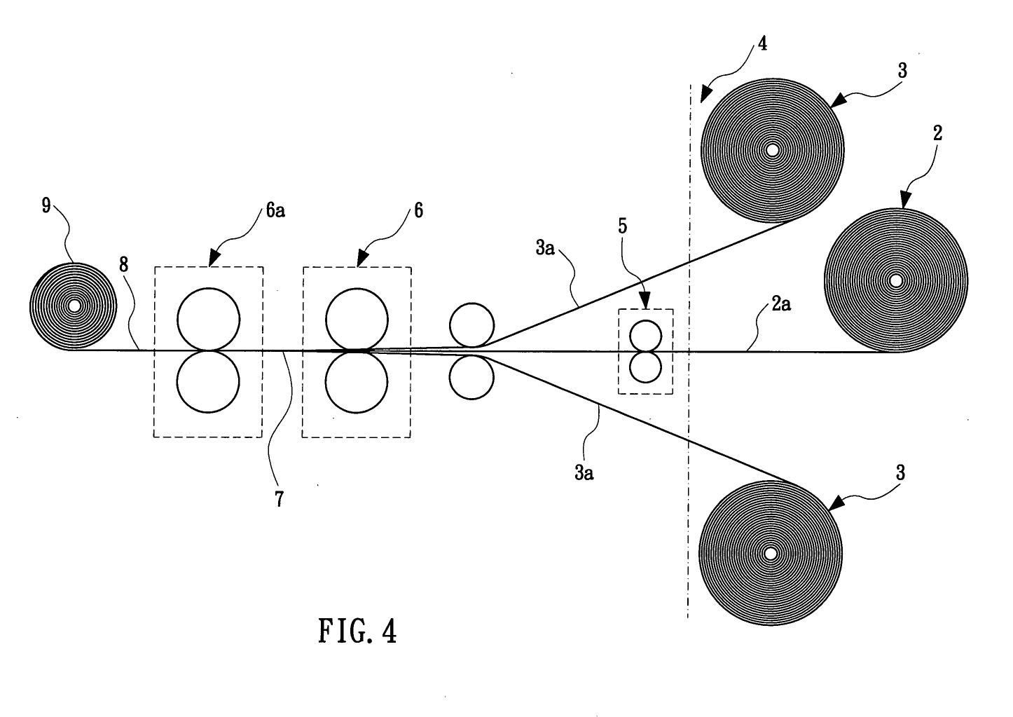

Referring to FIG. 4, it shows the manufacturing process for the slat 1 of Venetian Blind according to a first embodiment of the present invention shown in FIG. 3. An aluminum thin film coil 2 and two fabric coils 3 are set up in a feeding area 4. Before the heat-sealing operation, the aluminum thin film 2a of coil 2 has to pass through a coating area 5, in order to coat the adhesive layer 22 on the top and bottom surfaces of the aluminum thin film 2a. In laminating area 6, the aluminum thin film 2a of coil 2 shall be set between two fabrics 3a of coils 3. After the materials go through laminating area 6 and well laminated to become to a semi-finished slat 7, a machine is installed in trimming area 6a to heat-seal and heat-cut along the edge belts 21 in order to seal both sides of two fabrics 3a and cut away the excessive materials. For an actual slat product 8, the width of edge belt 21 which is reserved on slat product 8 shall be wide enough to cover said aluminum thin film 2a during heat-sealing and heat-cutting, but it is better to have smaller width, so that the slat product 8 has the best shaping effect. And the slat product 8 after heat-cutting/heat-trimming step may be collected into a coil 9. Besides, the arc forming process for increasing the strength or the rigidity of the slat product 8 can be done either on the said aluminum thin film 2a or on the slat product 8 whichever is more convenient. Also the laminating process (6) and heat-sealing and heat-cutting/heat-trimming process (6a) can be in one production line or in two separate line.

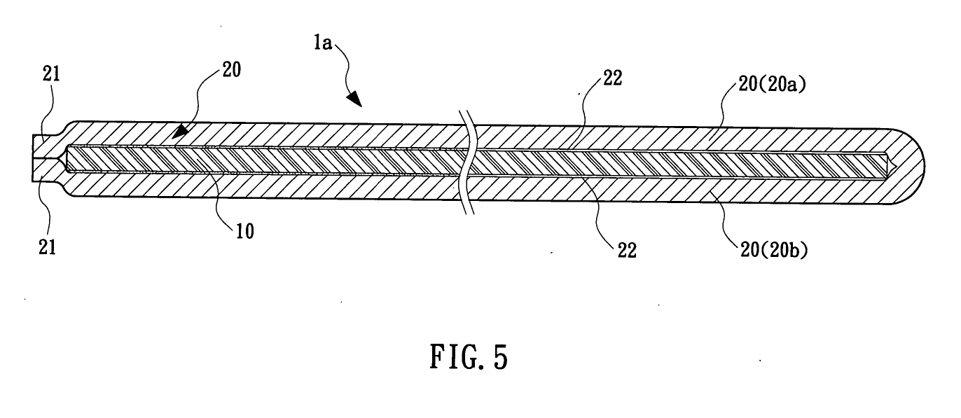

Referring to FIG. 5, the slat 1a of Venetian Blind of the present invention includes an inner thin film layer 10, and an outer layers 20 covered on surrounding surface of said inner thin film layer 10, wherein said inner thin film layer 10 is a thin film with suitable width and rigidity. Like the regular aluminum slat of Venetian Blind, its width is about 25-50 mm and thickness 0.13 or more. Said outer layers 20 is made up of fabric with heat-sealing property such as artificial fiber including polyester, nylon, or blended fiber etc. and it is wider than the double width of said inner thin film layer 10. Said outer layers 20 is folded into two connected halves 20a, 20b, and said two connected halves 20a, 20b are covered on the top and bottom of said inner thin film layer 10 with one edge belt 21 extending along one edge of said inner thin film layer 10. Because of the property of artificial fiber or blended fiber, the two halves 20a, 20b can be heat-sealed and heat-cut along the edge belt 21 to form a solid piece with the inner thin film layer 10 in between. And an adhesive layer 22 can be used to let two halves 20a, 20b and the inner thin film layer 10 tightly stick together to form the slat of Venetian Blind.

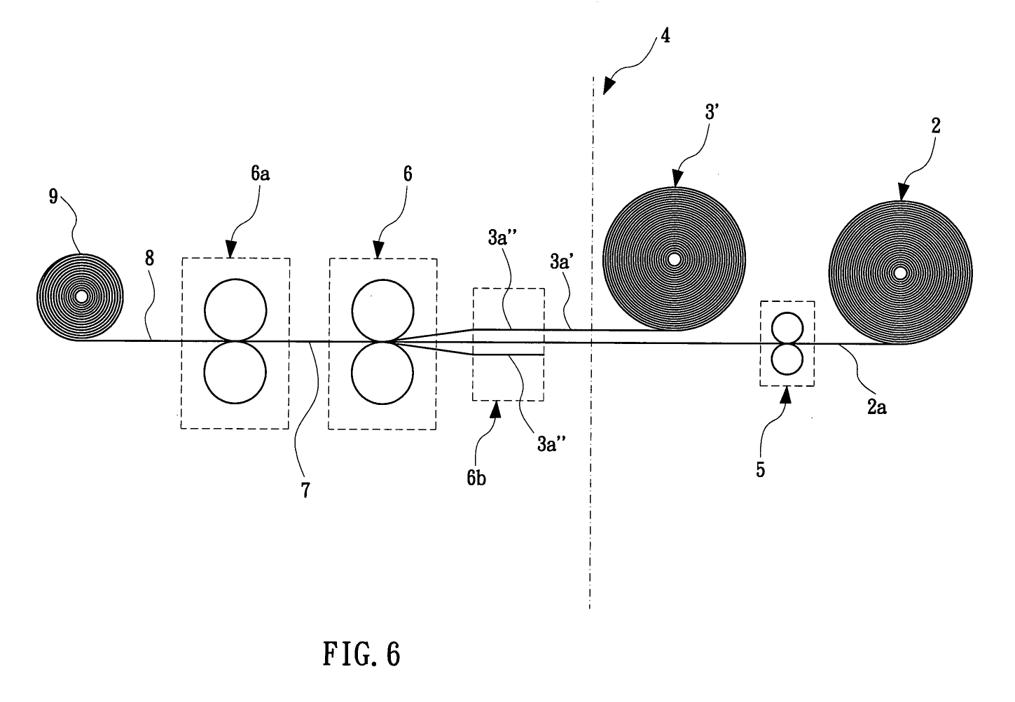

Referring to FIG. 6, it shows the manufacturing process for the slat 1a of Venetian Blind according to a first embodiment of the present invention shown in FIG. 5. An aluminum thin film coil 2 and a fabric coils 3′ are set up in a feeding area 4. Before the heat-sealing operation, the aluminum thin film 2a of coil 2 has to pass through a coating area 5, in order to coat the adhesive layer 22 on the top and bottom surfaces of the aluminum thin film 2a. Before laminating area 6, the fabric 3a′ is folded into two connected halves 3a″ in folding area 6b, and the width of each half 3a″ is wider than that of said aluminum thin film 2a. In laminating area 6, the aluminum thin film 2a of coil 2 shall be set between two connected halves 3a″. After the materials go through laminating area 6 and well laminated to become to a semi-finished slat 7, a machine is installed in trimming area 6a to heat-seal and heat-cut along the edge belts 21 in order to seal one side of two halves 3a″, and cut away the excessive materials. For an actual slat product 8, the width of edge belt 21 which is reserved on slat product 8 shall be wide enough to cover said aluminum thin film 2a during heat-sealing and heat-cutting, but it is better to have smaller width, so that the slat product 8 has the best shaping effect. And the slat product 8 after heat-cutting/heat-trimming step may be collected into a coil 9. Besides, the arc forming process for increasing the strength or the rigidity of the slat product 8 can be done either on the said aluminum thin film 2a or on the slat product 8 whichever is more convenient. Also the laminating process (6) and heat-sealing and heat-cutting/heat-trimming process (6a) can be in one production line or in two separate line.

What is claimed is:

1. A fabric slat of Venetian Blind, comprising an inner thin film layer and an outer surface layer covered on surrounding surface of said inner thin film layer, wherein said inner thin film layer is a thin film with suitable width and rigidity; said outer surface layer is made up of fabric with heat-sealing property, and its width is larger than that of inner thin film layer, and said outer surface layer are heat-sealed on surrounding surface of said inner thin film layer with two edge belts extended from both edges or one side along the width so as to make said outer surface layer heat-sealed to closed status.

2. A fabric slat of Venetian Blind as claimed in claim 1, wherein there is an adhesive layer between the top and bottom surface of said inner thin film layer and said outer surface layer.

3. A fabric slat of Venetian Blind as claimed in claim 1, wherein said inner thin film layer is aluminum thin film.

4. A fabric slat of Venetian Blind as claimed in claim 1, wherein said outer surface layer is made up of artificial fiber.

5. A fabric slat of Venetian Blind as claimed in claim 1, wherein said outer surface layer is made up of blended fiber.

6. A fabric slat of Venetian Blind as claimed in claim 1, wherein heat-sealed edge belt on the side of said outer surface layer is heat-cut/heat-trimmed to reduce the width.

7. A fabric slat of Venetian Blind as claimed in claim 1, wherein the width of said inner thin film layer is 25-50 mm.

8. A manufacturing method for the fabric slat of Venetian Blind comprising the steps of:
providing a thin aluminum film coil and two fabric coils, wherein the fabric of said two fabric coils is made up of fabric with heat-sealing property such as artificial fiber or blended fiber, and its width is wider than the thin aluminum film of said thin aluminum film coil;
coating an adhesive layer on the top and bottom of said aluminum film with adhesive;
laminating said two fabric on the top and bottom of said aluminum film with two fabric edge belts extending along both edges of said aluminum film;
heat-sealing along the fabric edge belts so as to heat-seal both sides of two fabric; and
heat-cutting/heat-trimming along the fabric edge belts so as to cut away the excessive materials of both sides of two fabric edge belts.

9. A manufacturing method for the fabric slat of Venetian Blind as claimed in claim 8, wherein the width of fabric edge belt which is reserved on slat is wide enough to cover said aluminum film during heat-sealing and heat-cutting/heat-trimming, but it is better to have smaller width.

10. A manufacturing method for the fabric slat of Venetian Blind as claimed in claim 8, wherein said aluminum film is formed an arc, and the arc forming process can be done before laminating step or heat-sealing step.

11. A manufacturing method for the fabric slat of Venetian Blind as claimed in claim 8, wherein said aluminum film is formed an arc, and the arc forming process can be done after laminating step or heat-sealing step.

12. A manufacturing method for the fabric slat of Venetian Blind as claimed in claim 8, wherein the slat after heat-cutting/heat-trimming step may be collected into a coil.

13. A manufacturing method for the fabric slat of Venetian Blind comprising the steps of:
providing a thin aluminum film coil and a fabric coil, wherein the fabric of said fabric coil is made up of fabric with heat-sealing property such as artificial fiber or blended fiber, and its width is wider than the double width of the thin aluminum film of said thin aluminum film coil;
coating an adhesive layer on the top and bottom of said aluminum film with adhesive;
folding the fabric into half-and-half fabric;
laminating said half-and-half fabric on the top and bottom of said aluminum film with two fabric edge belts extending along one edge of said aluminum film;
heat-sealing along the fabric edge belts so as to heat-seal one side of half-and-half fabric; and
heat-cutting/heat-trimming along the fabric edge belts so as to cut away the excessive materials of one side of two fabric edge belts.

14. A manufacturing method for the fabric slat of Venetian Blind as claimed in claim 13, wherein the width of fabric edge belt which is reserved on slat is wide enough to cover said aluminum film during heat-sealing and heat-cutting/heat-trimming, but it is better to have smaller width.

15. A manufacturing method for the fabric slat of Venetian Blind as claimed in claim 13, wherein said aluminum film is formed an arc, and the arc forming process can be done before laminating step or heat-sealing step.

16. A manufacturing method for the fabric slat of Venetian Blind as claimed in claim 13, wherein said aluminum film is formed an arc, and the arc forming process can be done after laminating step or heat-sealing step.

17. A manufacturing method for the fabric slat of Venetian Blind as claimed in claim 13, wherein the slat after heat-cutting/heat-trimming step may be collected into a coil.
